(19) United States
(12) Patent Application Publication
(10) Pub. No.: US 2010/0197368 A1
(43) Pub. Date: Aug. 5, 2010

(54) CABLE HARNESS BODY

(75) Inventors: Yoshihisa Kawate, Kanagawa (JP); Takuro Miya, Kanagawa Pref. (JP); Kohichiro Kawate, Tokyo (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 11/909,622

(22) PCT Filed: Apr. 4, 2006
(86) PCT No.: PCT/US06/12216

§ 371 Date: Sep. 25, 2007

(30) Foreign Application Priority Data
Apr. 7, 2005 (JP) 2005-111259

(51) Int. Cl. H04M 1/00; H01R 12/00; H01R 43/00

(52) U.S. Cl. 455/575.1; 174/72 A; 29/825

(57) ABSTRACT

To provide a connecting means that can facilitate electrical connection between the circuit boards mounted in an electronic apparatus and can attain the miniaturization of connecting parts. A cable harness body comprising a plurality of cables for electrically connecting circuit boards mounted in an electronic apparatus and the terminal members disposed on both ends of said cables, wherein at least one of said terminal members is comprised of a flexible circuit board and an adhesive layer on the surface of the electric connecting part of said flexible circuit board.

### FIELD

The present invention relates to a cable harness body that is composed of a plurality of cables and terminal members disposed on both ends of said cables.

### BACKGROUND

Recently, in line with the trend of miniaturization and higher precision of electronic components, circuits used for them are increasingly becoming higher density and higher precision. Accordingly, means for connecting with one another wiring boards having these micro circuits are being sought after.

For example, small-sized electronic apparatuses such as mobile phones generally have wiring boards having a plurality of micro circuits therein. Such mobile phones include folding type phones in which the first case and the second case are bound by a hinge mechanism, or revolving type phones in which the first case and the second case are bound by a rotating mechanism. Furthermore, in video camera recorders, the first case having the video camera body and the second case having the liquid crystal display for monitoring images are sometimes bound by a hinge mechanism. Electronic apparatuses of such shapes require means for connecting the first circuit board in said first case and the second circuit board in said second case.

Patent document 1 (Japanese Unexamined Patent Publication (Kokai) No. 2003-347005) discloses an electronic apparatus that electrically connects a first board disposed in the first case part to a second board disposed in the second case part thereby to support said first case part in a rotatable manner with respect to the second case part, said apparatus being capable of rotating the first case part with respect to the second case part with a first center axis as a center, and also capable of rotating it with respect to a second center axis perpendicular to the first center axis. In the electronic apparatus disclosed, the second board is inserted and mounted into a female connector fixed at the second case part, and a connector at the other end connected through a band flexible circuit from said female connector is connected to the first board, and thus the connection of the first board and the second board can be established.

As used herein, FIG. 1 is a perspective view of the conventional connecting means of a female connector and a board, and FIG. 2 is perspective view showing a conventional connecting means of a clip-type connector and a board. When a female connector (FC) is used, the wiring board (WB) must be designed so as to have an insertion part (I). On the other hand, a clip-type connector must be mounted onto a wiring board (WB) beforehand. Also, a female connector (FC) and a clip-type connector (CC) will become bulky, hindering the miniaturization of electronic apparatuses.

### SUMMARY

In the conventional connecting means, as described above, the design of a circuit board to be connected becomes very complicated, and also the structure of the connecting part is bulky, posing a problem that it cannot fully cope with the miniaturization of electronic apparatuses.

Thus, it is an object of the present invention to provide a connecting means that can facilitate electrical connection between the circuit boards mounted in an electronic apparatus and can attain the miniaturization of connecting parts.

According to one aspect, the present invention provides a cable harness body comprising a plurality of cables for electrically connecting circuit boards mounted in an electronic apparatus and terminal members disposed on both ends of said cables, wherein at least one of said terminal members is composed of a flexible circuit board and an adhesive layer on the surface of the electric connecting part of said flexible circuit board.

According to the cable harness body of the present invention, electric connection between the circuit boards mounted in the electronic apparatus can be easily performed by thermo-compression. Also, since the terminal member of the harness body has an adhesive layer mounted on the flexible circuit board, it can be miniaturized.

### BRIEF EXPLANATION OF THE DRAWINGS

FIG. 1 A perspective view of a conventional connecting means of a female connector and a board.

FIG. 2 A perspective view showing a conventional connecting means of a clip-type connector and a board.

FIG. 3 A perspective view showing one embodiment of the cable harness body of the present invention.

FIG. 4 A perspective view in the vicinity of the terminal member of another embodiment of the cable harness body of the present invention.

FIG. 5 A perspective view in the vicinity of the terminal member of another embodiment of the cable harness body of the present invention.

FIG. 6 A perspective view in the vicinity of the terminal member of another embodiment of the cable harness body of the present invention.

FIG. 7 A partially enlarged view of the structured body for grounding.

FIGS. 8a-8c Process steps showing the connecting method of the present invention.

FIG. 9 A perspective view of a mobile phone comprising a first circuit board and a second circuit board that were connected through the cable harness body of the present invention.

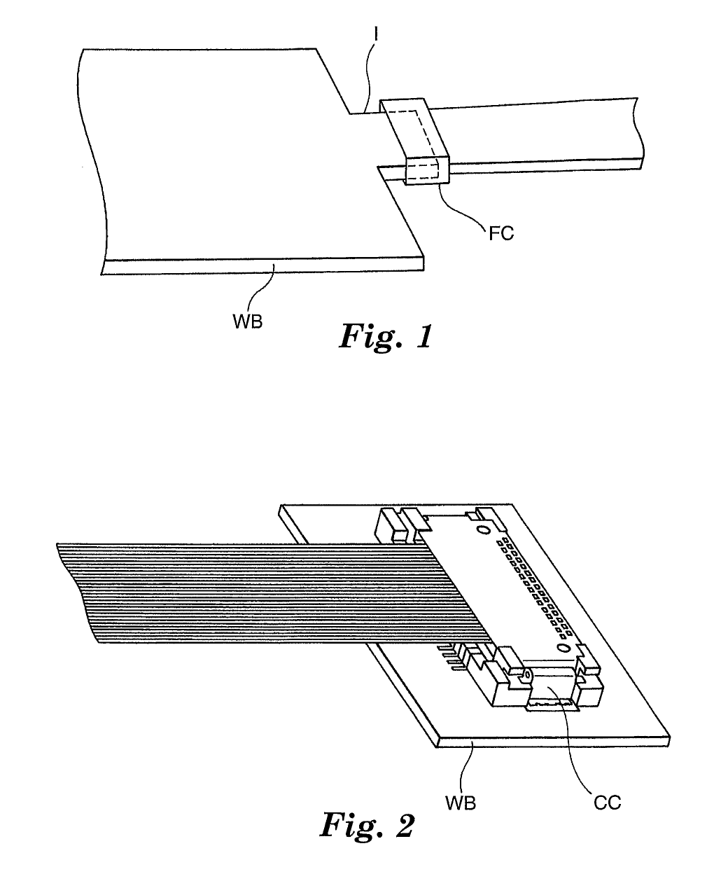

### DETAILED DESCRIPTION

Though the present invention will now be explained with reference to preferred embodiments below, it should be noted that the present invention is not limited to these specific embodiments in any way.

### Cable Harness Body

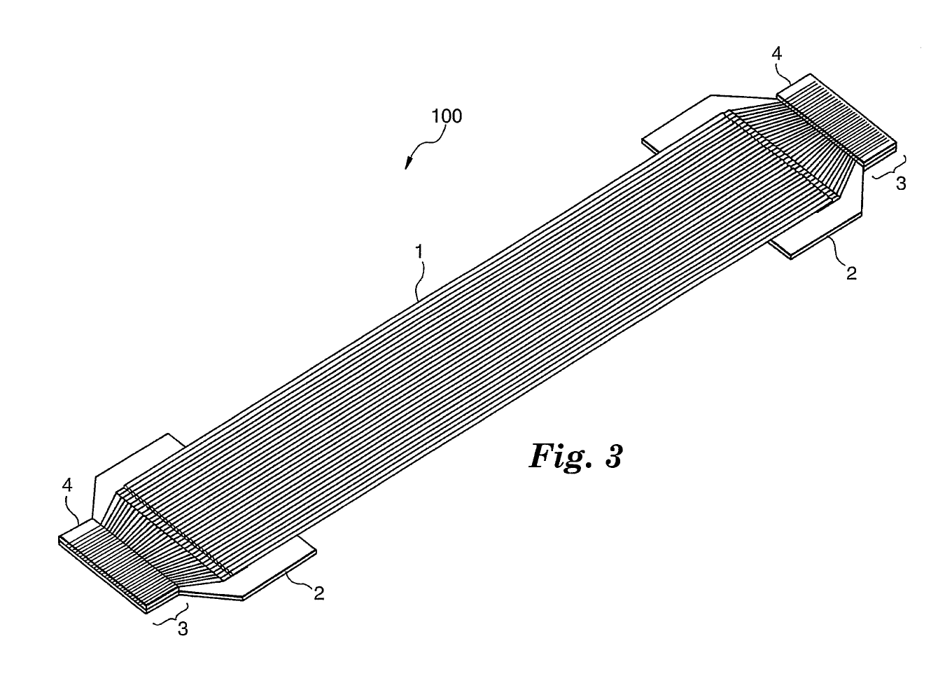

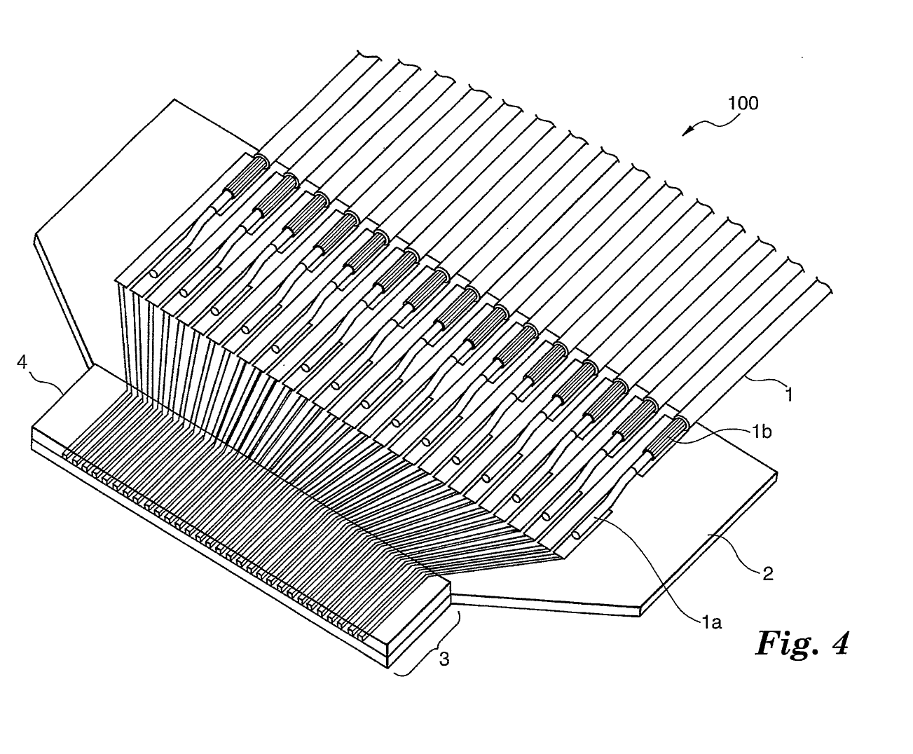

FIG. 3 is a perspective view showing one embodiment of the cable harness body of the present invention. The cable harness body 100 has a plurality of cables 1, and a flexible circuit board 2 such as a flexible printed circuit (FPC) as terminal members on both ends of said cable 1. It should be noted, however, that only one end of the terminal members may be a flexible circuit board 2, and the other may be any of the conventional connectors (for example connectors for fine coaxial lines). The flexible circuit board 2 has an adhesive layer 4 on the surface of an electric connection part 3.

The cable 1 and the flexible circuit board 2 may be connected by soldering, or by an adhesive. In particular, however, when the circuit of the flexible circuit board 2 is very fine, it is preferred to be connected with an adhesive in order to prevent short circuit with the neighboring circuits. As an adhesive of this purpose, a curable adhesive such as a thermosetting adhesive including an epoxy adhesive may be used and a permanent connection can be achieved with such adhesive.

FIG. 4 is a perspective view in the vicinity of the terminal member of another embodiment of the cable harness body of the present invention. The cable in the figure is a coaxial cable. Advantageously, coaxial cables permit the higher speed of signals, noise reduction, and higher density. In the cable harness body 100, the flexible circuit board 2 and the cable core 1a may be connected by soldering, or by an adhesive. In particular, however, when the circuit of the flexible circuit board 2 is very fine, it is preferred to be connected with an adhesive in order to prevent short circuit with the neighboring circuits. As an adhesive of this purpose, a curable adhesive such as a thermosetting adhesive including an epoxy adhesive may be used and a permanent connection can be achieved with such adhesive. An armored conductor 1b is also connected to the circuit of the flexible circuit board 2 so as to be grounded. Connection of the armored conductor 1b and the flexible circuit board 2 can be performed in a similar manner to that of the cable core 1a and the flexible circuit board 2.

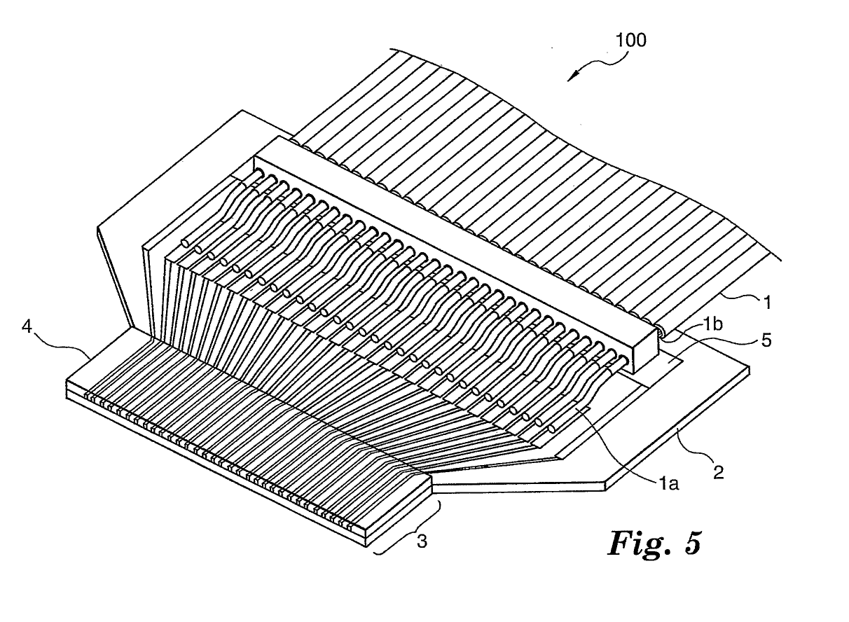

FIG. 5 is a perspective view in the vicinity of the terminal member of another embodiment of the cable harness body of the present invention. The cable 1 in the figure is a coaxial cable. It is different from the cable harness body of FIG. 4 in that a plurality of armored conductors 1b have been assembled together and bound to one grounding conductor 5 on the circuit board 2. The armored conductor 1b herein has been connected to the grounding conductor 5 by soldering.

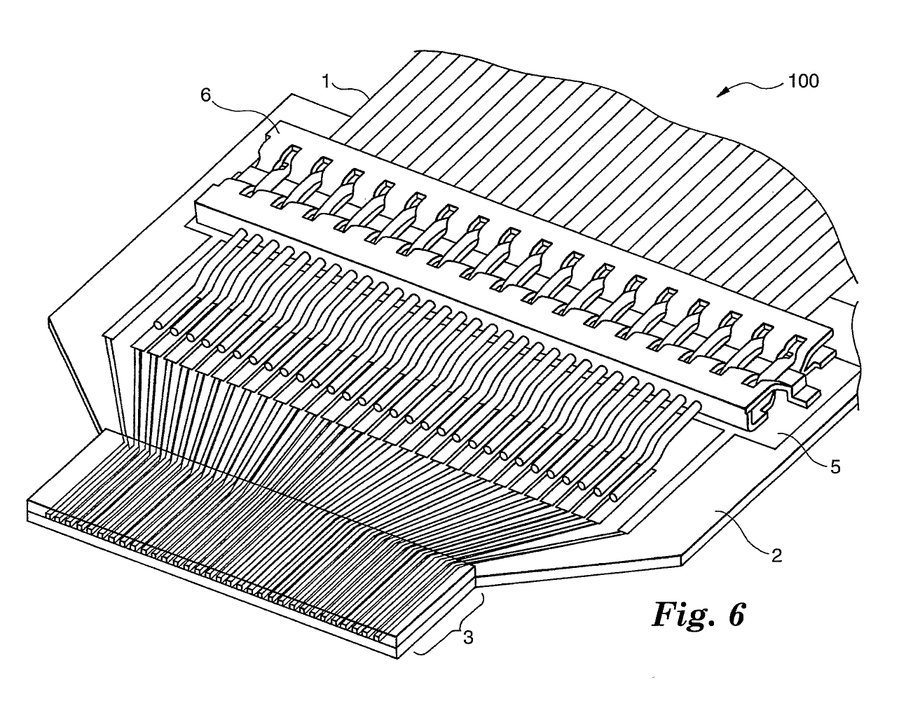

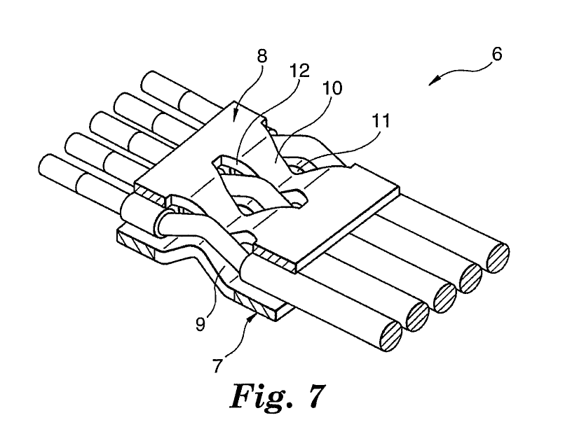

FIG. 6 is a perspective view in the vicinity of the terminal member of another embodiment of the cable harness body of the present invention. The cable 1 in the figure is a coaxial cable. It is different from the cable harness body of FIG. 5 in that a plurality of armored conductors 1b have disposed a structured body for grounding 6 on the grounding conductor 5. FIG. 7 is an enlarged partial figure of the structured body for grounding. The structured body for grounding 6 consists of a first member 7 and a second member 8. The first member 7 has a first elevation 9 and a first opening 11, and the second member 8 has a second elevation 10 and a second opening 12, and when the cable is fixed the first elevation 9 enters the second opening 12 and the second elevation 10 enters the first opening 11. With this type of structure, armored conductors 1b are connected to the conductor member 5 without using soldering or adhesive. When the coaxial cable 1 is a fine cable with the outer diameter of each coaxial cable of 0.3 mm or less, the use of such structured body for grounding 6 permits the prevention of short circuit with the neighboring circuits, for example, short circuit between a cable core 1a and an armored conductor 1b.

The surface of the electric connecting part of the flexible circuit board has an adhesive layer. The adhesive layer can be formed on the surface of the flexible circuit board by heating an adhesive film that makes an adhesive layer to a temperature where it melts, and then pressing (thermo-compressing) it. When a thermosetting adhesive is used as an adhesive layer, thermo-compression is performed at a temperature and a time period under which excessive thermosetting does not occur.

Preferably, the surface of the electric connecting part of the flexible circuit board contains a wiring that has a structured surface. As used herein the term “structured surface” means a substantially non-flat surface. Such a structured surface is set up so that when it is sandwiched and thermo-compressed between the electric connecting part of the circuit board to be connected and the electric connecting part of the flexible circuit board of the terminal part, the contact of the both electric connecting parts may be promoted, and thus electric connection may be favorably performed. The structured surface can be formed by positioning a plurality of liner groove parts with a pitch of 30-300 μm, a width of 30-150 μm, and a depth of 3-50 μm perpendicular to the flexible circuit board, and, loading them, as a load per conductor with a width of 100 μm, by a load of 2-100 kg (2-100 kg/100 μm wide, i.e. 19.5 N/100 μm wide-980 N/100 μm wide). A plurality of protruding structured surface can be obtained.

On the other hand, as another means for improving the contact of the electric connecting parts, for example, the wiring of said electric connecting part of the flexible circuit board may be made finer in width than the other wirings. By making it such a shape, the adhesive can easily be displaced during thermo-compression thereby enhancing the contact of the electric connecting parts with each other.

An adhesive layer is provided at the electric connecting part of the flexible circuit board. The adhesive layer only needs to electrically connect the electric connecting part of the circuit board to be connected and the electric connecting part of the cable harness body, and the adhesive to be used for the adhesive layer is preferably a thermosetting adhesive. It is because a thermosetting adhesive can secure the reliability of connection even when it is exposed to elevated temperature after connection. On the other hand, it is preferred that after the electric connecting part of the circuit board to be electrically connected and the electric connecting part of the flexible circuit board in the cable harness body were connected by thermo-compression through the thermosetting adhesive layer, the connection can be removed by heating without damaging the circuit board to be connected or the flexible circuit board of the harness body, and the connection can also be attained again by thermo-compression. Such a property is termed a “repair property.”

The circuit board to be connected by the cable harness body of the present invention may be, but not limited to, any suitable circuit board. Examples of suitable circuit boards include a glass epoxide-based circuit board, an aramide-based circuit board, a bismaleimide-triazine (BT resin)-based circuit board, a glass board or a ceramic board having a wiring pattern formed with ITO or metal fine particles, a rigid circuit board such as a silicon wafer having a metal conductor connecting part on the surface, or a flexible circuit board such as a flexible print circuit board (FPC).

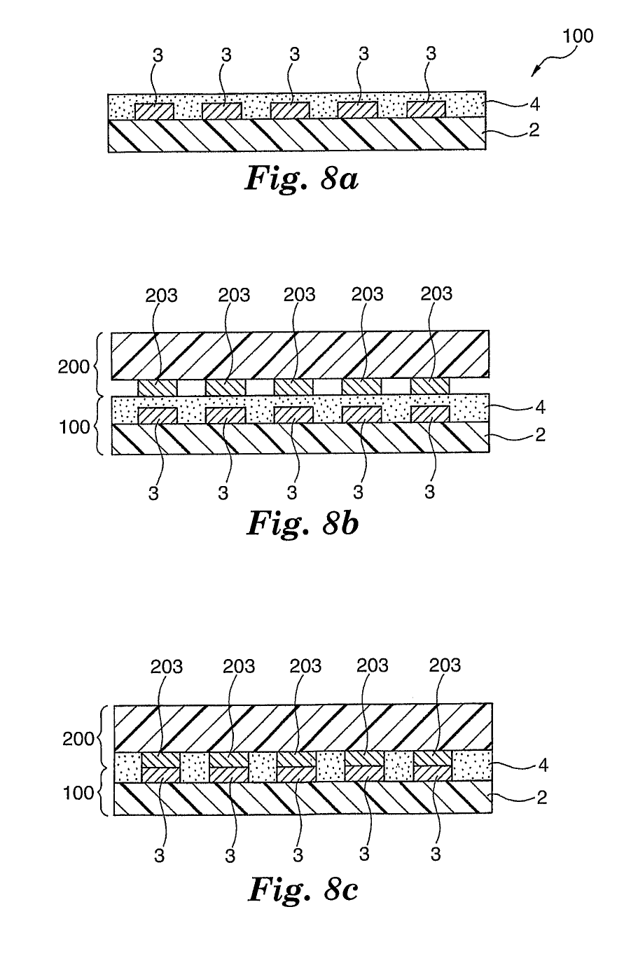

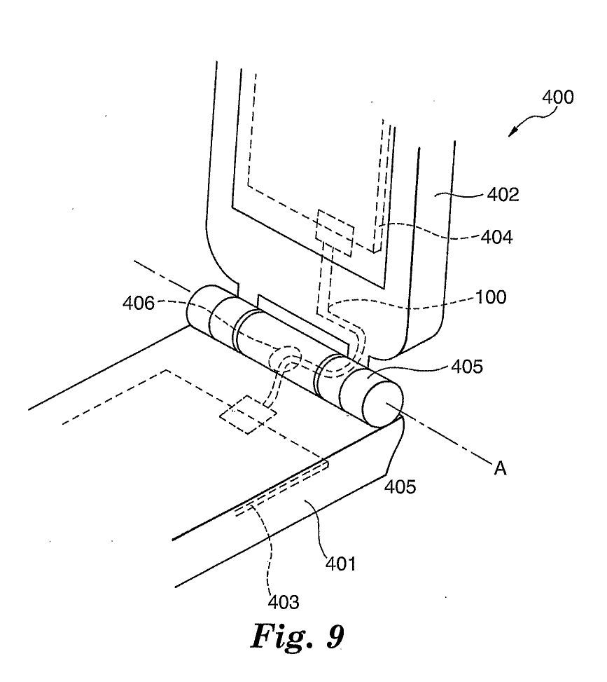

Hereinbelow, a method of connecting the cable harness body of the present invention will be explained according to the order of steps. FIG. 8 shows a flow chart of the connecting method of the present invention. First, a cable harness body 100 having an adhesive layer 4 on the electric connecting part 3 of the flexible circuit board 2 is prepared (step (a)). Then, a circuit board 200 to be connected using this cable harness body 100 is prepared, and the electric connecting part 3 of the cable harness body 100 and the electric connecting part 203 are aligned and superimposed through the adhesive layer 4 (step (b)). These superimposed cable harness body 100 and the circuit board 200 are thermo-compressed through the adhesive layer 4 to electrically connect the connecting portion 3 of the cable harness body 100 and the electric connecting part 203 of the circuit board 200 (step (c)). When the other end of the cable harness body 100 similarly has the adhesive layer 4 on the electric connecting part 3 of the flexible circuit board 2, the cable harness body 100 can be connected to the circuit board in a manner completely similar to that described above. Also, when the other end of the cable harness body is a connector of the conventional type, it can be connected to another circuit board in a conventional method. In this way, circuit boards can be connected by the cable harness body of the present invention.

Thermo-compression can be performed by a heat bonder such as a pulse heat bonder or a ceramic heat bonder capable of heating and compressing. When a heat bonder is used, an elastic sheet having heat resistance such as a polytetrafluoro ethylene (PTFE) film and a silicone rubber is preferably placed in between the flexible circuit board that is a terminal member of the cable harness body or the circuit board to be connected by the harness body and a bonder head.

Thermo-compression can be performed by pressing with a heated flat sheet. The temperature and pressure of thermo-compression may be determined by, but not limited to, the resin composition of the selected adhesive layer. In the present invention, generally there may be preferably used an adhesive agent that softens at about 100° C. or higher and for which the curing step can be performed at about 150° C.-250° C.

### Adhesive Layer

Next, the adhesive layer for use in the connection of the cable harness body of the present invention is described. The adhesive layer on the surface of the electric connecting part of the flexible circuit board in the cable harness body is not specifically limited as long as it can be connected by thermo-compression. However, since the circuit board connected by the harness body of the present invention is envisaged to be used at high temperature in an electronic apparatus, it is desired that the adhesive layer has heat resistance after adhesion. Thus, the adhesive layer is preferably a thermosetting adhesive composition comprising a resin that softens when heated to a certain temperature and cures by further heating so as to permit thermo-compression. Such a thermosoftening and thermosetting resin is a resin that contains both a thermoplastic component and a thermosetting component. In the first aspect, the thermosoftening and thermosetting resin can be a mixture of a thermoplastic resin and a thermosetting resin. In the second aspect, the thermosoftening and thermosetting resin can be a thermosetting resin that has been modified with a thermoplastic component. As an example of the second aspect, there can be mentioned a polycaprolactone-modified epoxy resin. In the third aspect, the thermosoftening and thermosetting resin can be a polymer resin having a thermosetting group such as an epoxy group in the basic structure of the thermoplastic resin. As an example of such a polymer resin, there can be mentioned a copolymer of ethylene and glycidyl(meth)acrylate.

A thermosetting adhesive composition that can be preferably used for the adhesive layer is a thermosetting adhesive composition comprising a caprolactone-modified epoxy resin. Such a thermosetting adhesive composition generally has a crystalline phase. The crystalline phase contains, as a main component, a caprolactone-modified epoxy resin (hereinafter referred to as “modified epoxy resin”). The modified epoxy resin has been designed to confer a suitable flexibility to the thermosetting adhesive composition so as to improve viscoelastic properties of a thermosetting adhesive. As a result, a thermosetting adhesive agent has an aggregating ability even before curing and exhibits an adhesive strength on heating. The modified epoxy resin also turns into a cured product having a three dimensional network structure on heating similarly to common epoxy resins, thereby conferring an aggregating ability to the thermosetting adhesive agent.

From a viewpoint of enhanced adhesive strength, such an epoxy resin generally has about 100 to about 9,000, preferably about 200 to about 5,000, and more preferably about 500 to about 3,000 epoxy equivalents. An example of a suitable modified epoxy resin having such epoxy equivalents has been commercially available in a trade name of, for example, PLAXEL G series (for example G402) available from Daicel Chemical Industries, Ltd.

Thermosetting adhesive compositions preferably contain a melamine/isocyanuric acid adduct (hereinafter referred to as a “melamine/isocyanuric acid complex”) in combination with the above-mentioned modified epoxy resin. A useful melamine/isocyanuric acid complex is commercially available in a trade name of, for example, MC-600 from Nissan Chemical Industries, Ltd., which is effective for reinforcing the thermosetting adhesive composition, reduction in tack of the thermosetting adhesive composition before thermosetting by the development of thixotropy, or the inhibition of hygroscopicity and fluidity of the thermosetting adhesive composition. In order to prevent brittleness without damaging the above effects, the thermosetting adhesive composition can generally contain this melamine/isocyanuric acid complex in the range of 1-200 parts by weight, preferably 2-100 parts by weight, and more preferably 3-50 parts by weight relative to 100 parts by weight of the modified epoxy resin.

Though thermosetting adhesive compositions also have strength sufficient to attain connection in the general use, they can preferably be softened on heating and cure so as to remove the connection without damaging the circuit board. By so doing, the repair property can be obtained. As used herein the term “repair property” means, as described above, an ability of reconnecting after peeling the adhesive layer by heating after the connection step.

When a caprolactone-modified epoxy resin is used as a thermosetting resin, a thermosetting adhesive composition can further contain a thermoplastic resin for an improved repair property. In accordance with the present invention, a repair property can be exhibited by separating the cable harness body and the circuit board at a temperature range of 120-200° C. after connecting, and then repeating the connecting step. A suitable thermoplastic resin is a phenoxy resin. Phenoxy resins are thermoplastic resins with a relatively high molecular weight having a branched or linear structure, and are formed from epichlorohydrin and bisphenol A. Such phenoxy resins have excellent processability, and a thermosetting adhesive composition can be easily processed into an adhesive film. According to one aspect of the present invention, this phenoxy resin is generally contained in the thermosetting adhesive composition in the range of 10-300 parts by weight and preferably 20-200 parts by weight relative to 100 parts by weight of the modified epoxy resin. This is because the phenoxy resin can become effectively compatible with the above epoxy resin. Thus, the bleed of the modified epoxy resin from the thermosetting adhesive composition can be effectively prevented. The phenoxy resin also can be effectively intertwined with the cured product of the above-mentioned modified epoxy resin, and thereby can further enhance the final aggregating ability, heat resistance etc. of the thermosetting adhesive layer.

Furthermore, when desired, thermosetting adhesive compositions can contain a second epoxy resin (hereinafter referred to simply as an “epoxy resin”) in combination with or independently of the above phenoxy resin. This epoxy resin is not specifically limited unless it departs from the scope of the present invention, and there can be used, for example, a bisphenol type A epoxy resin, a bisphenol type F epoxy resin, a bisphenol A diglycidyl ether type epoxy resin, a phenol novolac type epoxy resin, a cresol novolac type epoxy resin, a fluorene epoxy resin, a glycidyl amine resin, an aliphatic epoxy resin, a brominated epoxy resin, and a fluorinated epoxy resin. Similarly to the modified epoxy resin, such an epoxy resin is readily compatible with the phenoxy resin, and there is little bleed from the thermosetting adhesive composition. Specifically, in terms of enhanced heat resistance, it is advantageous that the thermosetting adhesive composition contains preferably 50-200 parts by weight and more preferably 60-140 parts by weight of the second epoxy resin relative to 100 parts by weight of the modified epoxy resin.

In the practice of the present invention, specifically a bisphenol A diglycidyl ether type epoxy resin (hereinafter referred to as a “diglycidyl ether type epoxy resin”) can be used as a preferred second epoxy resin. This diglycidyl ether type epoxy resin is liquid, and can improve, for example, the high-temperature characteristics of a thermosetting adhesive composition. For example, by using this diglycidyl ether type epoxy resin, chemical resistance and/or glass transition temperature due to curing at high temperature can be improved. Also, the scope of application of curing agents can be expanded, and curing conditions are relatively mild. Such a diglycidyl ether type epoxy resin is commercially available as, for example, D.E.R. 332 from Dow Chemical (Japan) Ltd.

A curing agent may be added as needed to a thermosetting adhesive composition, which can be subjected to a curing reaction of an epoxy resin. The amount used and the type of this curing agent is not specifically limited as long as it exhibits a desired effect. From a viewpoint of enhanced heat resistance, however, the curing agent is generally contained at 1-50 parts by weight, preferably 2-40 parts by weight, and more preferably 5-30 parts by weight relative to 100 parts by weight of the total amount of the epoxy resins. Curing agents include, but not limited to, the following: for example amine curing agents, acid anhydrides, dicyandiamides, cation polymerization catalysts, imidazole compounds, hydrazine compounds and the like can be used. Specifically dicyandiamides may be mentioned as promising curing agents in terms of thermal stability at room temperature.

For a thermosetting adhesive composition, 15-100 parts by weight of organic particles can be added relative to 100 parts by weight of said adhesive composition. Because of the addition of organic particles, the resin exhibits plastic fluidity whereas the organic particles maintain the flexibility of the thermosetting adhesive composition after curing. In the connecting step, even when moisture attached to the cable harness body or the circuit boards is evaporated on heating thereby exhibiting a water vapor pressure, the resin becomes fluid and does not contain air bubbles.

As the organic particles to be added, there may be used particles such as an acrylic resin, a styrene-butadiene resin, a styrene-butadiene-acrylic resin, a melamine resin, a melamine-isocyanurate additive, a polyimide, a silicone resin, a polyether imide, a polyether sulphone, a polyester, a polycarbonate, a polyether ether ketone, a polybenzimidazole, a polyarylate, a liquid crystal polymer, an olefin resin, and an ethylene-acrylic copolymer, and the size thereof is 10 μm or less and preferably 5 μm or less.

In order to heat-laminate FPC to the adhesive layer previously, thermo-compression may be performed at a heating temperature of about 150-230° C., a heating time of 1-10 seconds, and a pressure of 5-200 N/cm². Although this allows the adhesive film to soften and attach to FPC, curing takes place only slightly and the thermosetting property is maintained. Thermo-compression at the time of connecting of a cable harness body with a circuit board is performed at a temperature of 150-250° C. for one second to several minutes at a pressure of 5-200 N/cm².

In accordance with another aspect, the adhesive layer may be comprised of an anisotropic conductive adhesive composition containing conductive particles in the thermosetting resin component. A preferred anisotropic conductive adhesive composition having a repair property includes, for example, (1) an adhesive containing a cyanate ester, a film-forming thermoplastic resin and an epoxy resin; as well as (2) conductive particles. An anisotropic conductive adhesive composition most preferably comprises (1) an adhesive containing 100 parts by weight of a cyanate ester, 0.01-10 parts by weight of a catalyst, 10-300 parts by weight of a film-forming plastic resin, and 10-500 parts by weight of an epoxy resin; as well as (2) 0.1-20 parts by weight of conductive particles relative to 100 parts by weight of said adhesive.

The cyanate ester may be, for example, 2,2-bis(4-cyanophenyl)propane, bis(3,5-dimethyl)(4-cyanophenyl)methane, or an alicyclic cyanate ester. The catalyst may be, for example, an organic compound, a metal chelate compound, or an organic metal salt. The film-forming thermoplastic resin may be, for example, a polyvinyl butyral, a polyvinyl formal, a polyvinyl acetal, a polyamide, a phenoxy, a polysuphone, an epoxy acrylate, a glycidyl acrylate, a styrene-butadiene-styrene block copolymer, a carboxylated styrene-ethylene-butyrene-styrene block copolymer (SEBS), or an epoxylated SEBS, and the film-forming thermoplastic resin has a molecular weight of, for example, 3,000-200,000. Furthermore, the conductive particles can be metal particles, aggregated metal particles, molten metal particles, or particles in which a metal has been coated on a polymer nucleus material. It is desired that the diameter of the conductive particles is of such a size that does not cause short circuit with the neighboring circuits, and it is generally about 5-30 μm. The anisotropic conductive adhesive composition may be turned into a film by spraying the liquid onto the board and drying, which is then thermo-compressed onto the flexible circuit board of the cable harness body to obtain an adhesive layer. A cable harness body having such an adhesive layer can also be obtained in a manner similar to that for the thermosetting adhesive agent containing the above-mentioned caprolactone-modified epoxy resin. An anisotropic conductive adhesive composition that can be used in the present invention is described in, for example, Japanese Unexamined Patent Publication (Kokai) No. 5-28828.

In an electronic apparatus comprising a first case and a second case, the cable harness body of the present invention can be used for electrically connecting a first circuit board in the first case and a second circuit board in the second case. The electronic apparatus comprising the first case and the second case may be a mobile phone, a video camera recorder or the like. FIG. 9 is a perspective view of a mobile phone comprising the first circuit board and the second circuit board that have been connected by the cable harness body of the present invention. The mobile phone 400 has a first case 401 and a second case 402, the first case 401 and the second case 402 forming a connecting part 405 comprising a hinge mechanism at the terminal part, and are bound with the axis A as a center in a revolving manner. A connecting part 405 has an opening 406, through which a cable is allowed to pass. The first case 401 and the second case 402 each have a first circuit board 403 and a second circuit board 404, which have been bound by the cable harness body 100 of the present invention. In the cable harness body 100, the first circuit board 403 in the first case 401 and the second circuit board 404 in the second case 402 have been connected through the opening 406. Since the cable harness body 100 of the present invention uses a flexible circuit board as the terminal member, it becomes possible to pass through the small opening 406 by rounding the flexible circuit board. Thus, at the time of assembling the electronic apparatus, it can be presented in the form of a cable harness body having a terminal member, which simplifies the assembly step.

### Examples

The present invention will now be explained below with reference to examples. It should be noted, however, that the present invention is not limited to them in any way.

### 1. Manufacture of the Cable Harness Body of the Present Invention

### A. In the Case of a Flat Cable Having a Core Wire Conductor at a Predetermined Pitch (0.635 mm)

First a thermosetting adhesive composition having the composition described in the following Table 1 was prepared, and this was coated onto a siliconized polyethylene terephthalate (PET) film, which was dried in a 100° C. oven for 30 minutes to obtain an adhesive film with a thickness of 25 μm. A bundle of 50 cables for which the core wires of the terminals were exposed and two flexible circuit board were prepared, and the electric connecting parts of the cable and the flexible circuit board were aligned through the above adhesive film, which was subjected to thermo-compression at 175° C. or higher (a maximum temperature of 200° C.) and 19.6N (a 20 kg weight) for five seconds, and then the load was removed when the temperature dropped to 145° C. This yielded a cable harness body having a flexible circuit board on both ends. Then a mold having eight linear grooves with a pitch of 200 μm, a width of 100 μm and a height of 30 μm was adjusted with the electrical connection part of the flexible circuit board perpendicular to each other and they are pressed by a load of 400 kg weight (about 3920 N) to form a structured surface. Furthermore, an adhesive film with a thickness of 25 μm having the same composition as above was disposed on the electrical connection part of the flexible circuit board, and was heat laminated a 120° C. for several seconds to mold the cable harness body of the present invention having an adhesive layer.

The flexible print circuit (FPC) on both ends of the cable harness body was as follows:

FPC: Base material: polyimide (25 μm), conductor: gold/nickel/copper=0.3 μm/1.5 μm/18 μm, L/S (the electrically connected side in the following item 2)=100 μm/100 μm (L/S indicates a ratio of a width of the circuit conductor/width of the conductor), L/S (cable-connected side)=335 μm/300 μm, the number of circuits 50.

TABLE 1
Table 1: Composition of the adhesive agent

| | | Parts by |
|---|---|---|
| Name | Material | weight |
| YP50S | Phenoxy resin | 30 |
| DER332 | Epoxy resin | 34 |
| G-402 | Polycaprolactone-modified | 30 |
| | epoxy resin | |
| EXL-2314 | Acrylic polymer | 80 |
| DICY | Dicyandiamide | 209 |
| MeOH | Methanol | 40 |
| THF | Tetrahydrofuran | 550 |
| MC600 | Melamine isocyanuric | 20 |
| | acid complex | |

Note)
Phenoxy resin: YP50S, Toto Kasei, Number mean molecular weight 11,800
Epoxy resin: DER332, Dow Chemical Japan, Co., Ltd., epoxy equivalents 174
Polycaprolactone-modified epoxy resin: G402, Daicel Chemical Industries, Ltd. (epoxy equivalents 1350)
Acrylic particles: EXL2314 KUREHA PARAROID EXL, Kureha Chemical Industry, Co., Ltd.
DICY: Dicyandiamide CG-NA, PTI Japan Co., Ltd.
Memaline isocyanuric acid complex: MC-600, Nissan Chemical Industries, Ltd.

### B. In the Case of a Cable Harness Body Using a Coaxial Cable

The following shows a case in which the cable and the terminal member FPC were connected by soldering using a coaxial cable as the cable. The following is explained with reference to FIG. 5.

First, cables in which the core wire 1a and the armored conductor 1b were exposed in this order at the terminal of the cable were prepared and they were arranged at a predetermined pitch (0.3 mm). Then a flexible circuit board 2 was prepared, and the ends of core wires 1a of the coaxial cable were aligned to each land mounted on the circuit board 2, and the armored conductors 1b were collectively soldered to the grounding conductor 5 on the circuit board using a pulse heat bonder (manufactured by Nippon Avionics Co., Ltd.) (through a metal plate). At this time, the heater part of the bonder was heated to 280° C. Then, ends of cable wires 1a of the coaxial cable were soldered to each land mounted on the circuit board 2 under the same condition as above. This yielded a cable harness body having a flexible circuit board on both ends. Then, a mold having eight linear grooves with a pitch of 200 μm, a width of 100 μm and a height of 30 μm was adjusted with the electrical connection part 3 of the flexible circuit board perpendicular to each other and they are pressed by a load of a 400 kg weight (about 3920 N) to form a structured surface. Furthermore, an adhesive film with a thickness of 25 μm having the same composition as above was disposed on the electrical connection part 3 of the flexible circuit board, and was heat laminated a 120° C. for several seconds to mold the cable harness body of the present invention having an adhesive layer.

The flexible print circuit board (FPC) on both ends of the cable harness body was as follows:

FPC: Base material: polyimide (25 μm), conductor: gold/nickel/copper=0.3 μm/1.5 μm/18 μm, L/S (the electrically connected side of the following item 2)=100 μm/100 μm (L/S shows a ratio of a width of the circuit conductor/width of the conductor), L/S (the cable-connected side)=150 μm/150 μm, the number of circuits 50.

### 2. Electric Connection

The above cable harness body was connected to a print circuit board (PCB) having the following composition:

PCB: Base material: PR-4 (a glass epoxy board with a thickness of 0.4 mm), conductor: gold/nickel/copper=0.3 μm/1.5 μm/18 μm, L/S=100 μm/100 μm, the number of circuits 50.

The electric connecting part of the flexible circuit board having an adhesive layer and the electric connecting part of the print circuit board were aligned, and the electric connecting parts were thermo-compressed through the adhesive layer to establish electric connection. The thermo-compression was performed at 175° C. or higher (a maximum temperature of 200° C.) and 19.6N (a 20 kg weight) for five seconds, and then the load was removed when the temperature dropped to 145° C. For all the cables, good electric connection was confirmed.

### 3. Removal of Connection

The peeling of the above electric connecting part was attempted by heating on a 150° C. heater. It was possible to remove the connection without damaging PCB or FPC.

### 4. Repair Property

After breaking connection as described above, connection was performed again in the same condition as above, and it was confirmed that good connection can be established again.

1. A cable harness body comprising a plurality of cables for electrically connecting circuit boards mounted in an electronic apparatus and the terminal members disposed on both ends of said cables, wherein at least one of said terminal members is composed of a flexible circuit board and an adhesive layer on the surface of the electric connecting part of said flexible circuit board.

2. The cable harness body according to claim 1 wherein said surface of said electric connecting part of said flexible circuit board comprises a wiring having a structured surface.

3. The cable harness body according to claim 2 wherein the wiring of said electric connecting part of said flexible circuit board is finer in width than the other wirings.

4. The cable harness body according to claim 1 wherein said adhesive layer is an adhesive layer comprising a thermosetting component.

5. The cable harness body according to claim 4 wherein said adhesive layer further comprises organic particles.

6. The cable harness body according to claim 4 wherein said adhesive layer comprises a thermosetting adhesive composition containing a caprolactone-modified epoxy resin.

7. The cable harness body according to claim 4 wherein said adhesive layer comprises an anisotropic conductive adhesive composition containing conductive particles in the thermosetting resin component.

8. A method of connecting circuit boards to be mounted in an electronic apparatus with one another wherein the electric connecting part of the circuit board to be mounted in an electronic apparatus and the electric connecting part of the flexible circuit board in the cable harness body according to claim 1 are aligned, and said electric connecting parts are thermo-compressed with one another through said adhesive layer.

9. A mobile phone containing a first case and a second case wherein a first circuit board in said first case and a second circuit board in said second case are electrically connected by the cable harness body according to claim 1.
